(19) United States
(12) Patent Application Publication
(10) Pub. No.: US 2026/0301982 A1
(43) Pub. Date: Oct. 1, 2026

(54) RESOURCE USAGE PREDICTION METHOD OF PLASMA CONTROL SYSTEM BASED ON LSTM

(71) Applicant: HEFEI INSTITUTES OF PHYSICAL SCIENCE, CHINESE ACADEMY OF SCIENCES, Hefei (CN)

(72) Inventors: Qiping YUAN, Hefei (CN); Junjie HUANG, Hefei (CN); Ruirui ZHANG, Hefei (CN); Zhongmin HUANG, Hefei (CN); Jianqiu ZHU, Hefei (CN); Gen XU, Hefei (CN); Bingjia XIAO, Hefei (CN)

(73) Assignee: HEFEI INSTITUTES OF PHYSICAL SCIENCE, CHINESE ACADEMY OF SCIENCES, Hefei (CN)

(21) Appl. No.: 19/451,937

(22) Filed: Jan. 16, 2026

(30) Foreign Application Priority Data
Mar. 28, 2025 (CN) 202510381301.1

(51) Int. Cl. G21D 3/00; G06F 9/50; G21B 1/05

(52) U.S. Cl. CPC G21D 3/001; G06F 9/5016; G21B 1/057

(57) ABSTRACT

The disclosure relates to the technical field of the nuclear fusion tokamak device control system, in particular to a resource usage prediction method of a plasma control system based on LSTM. The technical solution thereof includes data preprocessing and feature extraction, introducing an LSTM network for time series prediction, feature embedding and feature separation strategies, standard value prediction and memory leakage detection, health index calculation and feedback adjustment, and feedback adjustment in a prediction period. The disclosure is used to predict a standard value of resource usage during operation of the system and determine whether the resource usage deviates excessively from the standard value by comparing the standard value with real-time monitoring data. It can capture long-term dependencies and nonlinear variation patterns of the resource usage of the system and is particularly suitable for processing complex periodic waveforms. It can not only improve the accuracy of the prediction of the standard value, but also more effectively evaluate the health status of the system and provide an early warning of potential abnormal conditions, thus providing important support for the stable operation of the system.

### CROSS REFERENCE TO RELATED APPLICATIONS

This application claims priority to Chinese Patent Application No. 2025103813011, filed on Mar. 28, 2025, the entire content of which is incorporated herein in its entirety.

### TECHNICAL FIELD

The disclosure relates to the technical field of nuclear fusion tokamak device control system, and in particular to a resource usage prediction method of a plasma control system based on Long Short-Term Memory (LSTM).

### BACKGROUND

Due to the functional complexity and the dynamic nature of the operating environment of a plasma control system (PCS), it is critical to evaluate the system health status in real time and to predict benchmark values for resource usage in order to ensure stable system operation. PCS usually needs to handle multiple real-time tasks, and the algorithms or functions running at different times vary. Consequently, the occupations of resources such as the CPU and the memory show significant dynamic characteristics. In addition, because many control algorithms and functions are encapsulated in the form of “black box”, external systems cannot directly know the variation patterns of their internal resource consumption, which brings great challenges to real-time health assessment and resource scheduling.

Traditional health monitoring methods usually rely on real-time monitoring of key performance indicators (KPIs) such as CPU occupancy rate and memory usage rate, but these methods can only capture static data at the current moment and lack the ability to analyze and determine the long-term variation trend of indicators. This makes it difficult for the system to predict the abnormal situations of resource usage in time, especially in tasks with periodic fluctuation characteristics (such as intermittent discharge mode in PCS), and the resource usage waveform presents the characteristics of alternating busy and non-busy regions. When faced with such a complex dynamic waveform, it is difficult for traditional methods to provide accurate reference standards for health assessment, thus affecting the accuracy of health status determination and resource scheduling.

Therefore, the present disclosure proposes a resource usage prediction method of a plasma control system based on LSTM.

### SUMMARY

A purpose of the disclosure is to propose a resource usage prediction method of a plasma control system based on LSTM, to address the problem that exists in the background that traditional health monitoring methods usually rely on real-time monitoring of key performance indicators (KPIs) such as CPU occupancy rate and memory usage rate, and lack the ability to analyze and determine the long-term variation trend of indicators.

The technical solution of this invention is: a resource usage prediction method of a plasma control system based on LSTM, the method includes the following steps:
data preprocessing and feature extraction: collecting and processing operation data of the plasma control system, selecting and standardizing feature metrics reflecting an operation state of the system;
introduction of an LSTM network for time series prediction: constructing an LSTM model, training the model using historical data to predict a resource usage standard value at a future time point, and enhancing an adaptability of the model through a sliding window method;
feature embedding and feature separation strategies: generating embedded vectors for a system state, and separating a memory waveform according to busy and non-busy regions;
standard value prediction and memory leakage detection: collecting operation data of the system in real time, applying the LSTM model to predict a resource usage standard value in the future, calculating and monitoring a difference between the actual memory waveform and the predicted standard value and an increment of the difference to detect a memory leakage;
health index calculation and feedback adjustment: calculating a health index of the system based on the actual difference, introducing a time decay factor, and adjusting the health index when a memory leakage is detected;
feedback adjustment in the prediction period: according to a memory leakage detection result, performing feedback and adjustment on the input of the prediction, and performing cyclic predictions at a certain time step.

Optionally, the data preprocessing and feature extraction specifically include:
data collection: collecting time series data about resource usage including CPU occupancy rate and memory allocation during operation of the system, ensuring that the data includes resource consumption conditions under different operation states of the system;
feature selection: selecting feature metrics reflecting the running state of the system, wherein the feature metrics include:
   algorithm type: a type of control algorithm currently running;
   trigger state: a state of the system when the system is in different trigger conditions;
   operation stage: an operation stage of the control system; the operation stage includes initialization, operation, and pause;
dynamic resource utilization: dynamically changing resource utilization data, including historical CPU occupancy rate and memory allocation;
standardization processing: standardizing input features to eliminate a scale difference between different features and to ensure a stability and efficiency of model training.

Optionally, the introduction of an LSTM network for time series prediction specifically includes:
model structure determination: constructing the LSTM model, setting an input window to 200 time steps, wherein the input features of the model include the CPU occupancy rate and the memory allocation of a previous step, and the current system state;
time series learning: training the LSTM model using historical data, wherein by learning a relationship between different system operation stages and resource usages, the model is configured to predict a resource usage standard value at a future time point; the resource usage standard value includes a standard CPU occupancy rate and a standard memory value;
model training: segmenting the training data into a plurality of small windows through a sliding window method, to cover all possible operation states and to enhance the model's adaptability to resource fluctuations.

Optionally, the feature embedding and feature separation strategies specifically include the following steps:
feature embedding: performing a statistical analysis on the system state to generate the embedded vectors to replace traditional digital coding, wherein the system state includes the algorithm type and the trigger state;
feature separation: in view of an obvious square wave characteristic of the memory waveform, separating the memory occupancy rate into busy regions and non-busy regions, and using the separated busy and non-busy regions as independent input features for the LSTM model to learn, the obvious square wave characteristic of the memory waveform is that the busy regions and the non-busy regions change alternately.

Optionally, the step of the standard value prediction is as follows:
real-time data collection: collecting resource usage data including CPU occupancy rate and memory allocation in real time during the operation of the system to form a time series;
application of LSTM prediction model: predicting a resource usage condition of the system within a future time period (for example, within 10 seconds) by using the trained LSTM network model, wherein the LSTM model predicts a standard CPU occupancy rate and a memory allocation value at a future time point based on historical data, the historical data includes a CPU occupancy rate, a memory usage condition, and a control algorithm type;
input features: including a control algorithm type, a trigger state, and system state characteristics of the operation stage at a current time, combined with CPU and memory occupancy information at a previous time, to provide sufficient context information for the LSTM model;
prediction process: a time series relationship learned by the LSTM model during the training process, is used to predict the resource usage standard value Mₚ(t) within a future time period, the resource usage standard value includes a standard memory value and a standard CPU occupancy rate;
standard value output: the standard value Mₚ(t) outputted by the LSTM model is an “ideal” value of future resource usage inferred by the model based on historical data, the standard value serving as a benchmark for health assessment is used to compare with actual memory usage data.

Optionally, the memory leakage detection specifically includes the following steps:
comparing with actual memory usage condition:
acquiring actual memory usage data: monitoring the actual memory waveform Mᵣ(t) of the system in real time, that is, a current memory occupancy of the system;
calculating a difference: calculating a difference between the actual memory waveform Mᵣ(t) and the predicted standard value Mₚ(t), that is,

$$D ( t ) = \vert {M}_{r} ( t ) - {M}_{p} ( t ) \vert$$

wherein D(t) is a difference value at a current time point t, representing a deviation between the actual memory usage and the predicted standard value;
calculating a difference increment:
calculating the difference increment ΔD(t): in order to detect an occurrence of memory leakage, calculating a rate of change of the difference D(t), that is, the difference increment ΔD(t)=diff(D(t)), is required, wherein diff (D(t)) represents a difference increment calculated based on a variation of the difference value D(t) over time, reflecting changes in the deviation between the actual memory usage and the standard value;

detecting memory leakage:

determining whether the difference increment exceeds a threshold: if the difference increment ΔD(t)>leakageThreshold, it is considered that a memory leakage has occurred, and the threshold is determined by experimental data or experience, signifying that the deviation between the actual memory usage and the predicted value increases excessively fast, suggesting that there may be a resource leakage;
setting memory leakage state: at this time, the memory leakage state is set as follows:

$$isLeakage ( t ) = \{ \begin{matrix}1 , if Δ D ( T ) > leakageThreshold \\ 0 , otherwise\end{matrix}$$

wherein, isLeakage(t)=1 indicates that a memory leakage is detected in the system, and isLeakage(t)=0 indicates that no memory leakage is detected.

Optionally, the health index calculation and feedback adjustment specifically includes the following steps:
calculating the health index: in the resource usage prediction method of a plasma control system based on LSTM, the health index of the system needs to be calculated based on the actual difference, and the health index is defined as:

$$H ( t ) = 1 - \frac{D ( t )}{max {M}_{p} ( t )}$$

the health index H(t) indicates a degree of health of the system; the smaller the difference D(t), the higher the health index; the health index H(t) is configured to evaluate a health status of resource usage of the system in real time;
introducing a time decay factor: introducing the time decay factor

$${e}^{- \frac{t}{τ}} ,$$

to simulate a decay of the health status over time, wherein τ is a decay constant controlling a decay speed; such decay factor ensures that the health status gradually decreases over time, preventing an overly optimistic health assessment over a long period of time.
health index adjustment in memory leakage state: if a memory leakage is detected, that is, isLeakage(t)=1, then the health index will decline rapidly, and the health index is multiplied by the decay factor to represent a rapid deterioration of the health status of the system, the calculation formula is:

$${H}_{result} ( t ) = \{ \begin{matrix}{H}_{withT} ( t ) ifisLeakag e ( t ) = 1 \\ H ( t ) otherwise\end{matrix}$$

wherein,

$${H}_{withT} ( t ) = H ( t ) {e}^{- \frac{t}{τ}}$$

is the health index after the time decay is introduced, representing the rapid decline of the health status of the system in the case of memory leakage.

Optionally, the feedback adjustment in the prediction period specifically includes the following steps:
feedback adjustment: if the system detects no memory leakage, using the actual memory waveform Mᵣ(t) as an input, and continuing to predict the standard value at a next time point; and if a memory leakage is detected, using the predicted standard memory waveform Mₚ(t) as an input for the next period instead of using the actual memory waveform Mᵣ(t);
cyclic prediction: the prediction cycle performs iterative prediction in the prediction period at 10-second and 20-second time steps, to continuously monitor the health status and the resource usage of the system.

Compared with the prior art, the present disclosure includes at least one of the following beneficial technical effects:

By introducing LSTM, the long-term dependence and dynamic change characteristics of resource usage in PCS are effectively captured. By combining the feature embedding and feature separation strategies, the accuracy of prediction of the CPU occupancy rate and memory allocation is significantly improved, especially under a complex periodic waveform.

By taking the predicted standard value of resource usage as a basis to compare in real-time with the actual value, the health status of the system can be accurately determined. By combining with the time decay mechanism of the health index, the system is more intuitive in the dynamic changes of health status, thereby supporting rapid diagnosis and locating of potential problems.

The proposed memory leakage detection algorithm can identify a memory leakage trend in real time by calculating a difference between the actual value and the standard value and a difference increment. This method can effectively avoid misjudgment caused by resource fluctuation and improve the sensitivity and reliability of system fault detection.

Through the feedback adjustment mechanism, when a memory leakage occurs, the predicted standard value is used instead of the actual value as the input for the next period, thereby preventing the negative impact of the memory leakage on the model prediction, and maintaining the high efficiency and accuracy of the resource usage prediction.

By adopting a sliding window method and the multi-stage training data, the adaptability of the LSTM model to different scenarios during PCS operation is enhanced. Whether in an initialization, operation or abnormal stage, the technical solution of the present disclosure can effectively respond.

Through the real-time feedback of the health index and memory leakage detection results, the system can identify and respond to potential risks at an early stage, reduce system interruptions or experimental delays caused by failures, and improve the reliability and safety of system operation.

The technical solution of the disclosure is not only applicable to the prediction of the CPU occupancy rate and memory allocation, but can also be extended to other resources, thus providing a general solution for the overall resource optimization and health evaluation of the system.

The disclosure is used for predicting the standard value of resource usage during the operation of the system and determining whether the resource usage deviates excessively from the standard value by comparing it with real-time monitoring data. By learning historical operation data, the LSTM network can capture the long-term dependence and nonlinear change patterns of resource usage of the system and is especially suitable for processing a complex periodic waveform. In addition, this method combines the feature embedding and feature separation strategies, which can not only improve the accuracy of predicting the standard value, but can also more effectively evaluate the health status of the system and warn of potential abnormalities in advance, thereby providing important support for the stable operation of the system.

### BRIEF DESCRIPTION OF THE DRAWINGS

FIG. 1 is a graph of a comparison between a predicted waveform and an actual waveform—a comparison of predicted and actual memory usage waveforms;

FIG. 2 is a graph of a comparison between a predicted waveform and an actual waveform—average absolute error curves for different predictions;

FIG. 3 is a graph of a comparison between a predicted waveform and an actual waveform—mean square error curves for different predictions;

FIG. 4 is a graph of a comparison between a predicted waveform and an actual waveform—determination coefficient curves for different predictions;

FIG. 5 is a graph of a comparison between a predicted waveform and an actual waveform in 10 seconds—CPU occupancy rate: 10-second prediction accuracy;

FIG. 6 is a graph of a comparison between a predicted waveform and an actual waveform in 10 seconds—memory usage amount: 10-second prediction accuracy.

### DETAILED DESCRIPTION OF THE EMBODIMENTS

The technical solutions of the present disclosure will be further described below with reference to the accompanying drawings and specific embodiments.

### Embodiment 1

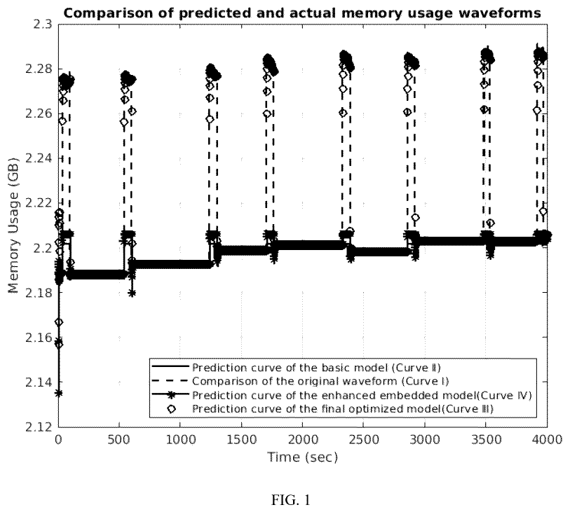

As shown in FIG. 1, this invention provides a resource usage prediction method of a plasma control system based on LSTM. The method includes data preprocessing and feature extraction, introducing an LSTM network for time series prediction, feature embedding and feature separation strategies, standard value prediction and memory leakage detection, health index calculation and feedback adjustment, and feedback adjustment in a prediction period. The following provides detailed descriptions for each step.

### Step 1: Data Preprocessing and Feature Extraction

Before model training, the historical operation data of the system needs to be preprocessed first. The specific steps are as follows:
1 Data collection: collecting time series data regarding resource usage including CPU occupancy rate, memory allocation resource usage, and the like during the operation of the system, to ensure that the data includes resource consumption conditions under different operation states of the system.
2 Feature selection: selecting feature metrics reflecting the running state of the system are selected, mainly including:
Algorithm type: the type of control algorithm currently running.
Trigger state: the state of the system under different trigger conditions.
Operation stage: the operation stage of the control system (which includes initialization, operation, and pause).
Dynamic resource utilization: including dynamically changing resource utilization data such as historical CPU occupancy rate, memory allocation, and the like.
Standardization processing: standardizing the input features to eliminate a scale difference between different features to ensure the stability and efficiency of model training.

### Step 2: Introduction of an LSTM Network for Time Series Prediction

After data preprocessing and feature extraction, an LSTM network is used to predict the CPU occupancy rate and memory allocation of the system. The LSTM network is suitable for processing time series data and can capture long-term dependencies in the data. The specific steps are as follows:
1 Model structure determination: constructing an LSTM model, setting an input window to 200 time steps, wherein input features of the model include the CPU occupancy rate and the memory allocation of a previous step, the current system state, and the like.
2 Time series learning: training the LSTM model using historical data, wherein the model predicts a resource usage standard value (such as a standard CPU occupancy rate and a standard memory value) at a future time point through learning the relationship between different system operation stages and resource usage.
3 Model training: segmenting the training data into a plurality of small windows through a sliding window method to cover all possible operation states and enhance the adaptability of the model to resource fluctuations.

### Step 3: Feature Embedding and Feature Separation Strategies

In Order to Further Improve the Prediction Accuracy, the Present Disclosure Introduces Feature Embedding and Feature Separation Strategies in the LSTM Model:
1 Feature embedding: performing a statistical analysis on the system state (such as the algorithm type and the trigger state) to generate the embedded vectors to replace traditional digital coding. These embedded vectors have physical significance and can better reflect the characteristics of resource usage, thereby enhancing the model's modeling ability for the nonlinear relationship between the system state and the resource usage.
2 Feature separation: in view of an obvious square wave characteristic (i.e., the busy regions and the non-busy regions change alternately) of the memory waveform, separating the memory occupancy rate into busy regions and non-busy regions, and using the separated busy and non-busy regions as independent input features for the LSTM model to learn. This separation method effectively reduces the interference of resource usage fluctuations at different stages and improves the model's ability to predict complex waveforms.

### Step 4: Standard Value Prediction and Memory Leakage Detection

The standard value prediction and memory leakage detection in the disclosure are based on comparing the output of the LSTM prediction model with the actual memory usage, so as to determine whether a memory leakage occurs in the system. The process is divided into the following several steps, aiming to improve memory usage prediction accuracy, and detect potential memory leakage problems in the system by comparing the difference between the predicted standard value and the actual value.

### 1 Standard Value Prediction:

Real-time data collection: collecting resource usage data such as CPU occupancy rate and memory allocation in real time during the operation of the system to form a time series.

Application of LSTM prediction model: predicting a resource usage condition of the system within a future time period by using the trained LSTM network model. Specifically, the LSTM model predicts a standard CPU occupancy rate and a memory allocation value for a future period of time (e.g., 10 seconds) based on historical data (such as CPU occupancy rate, memory usage condition, and control algorithm type characteristics).

Input features: including the control algorithm type, trigger state, and system state characteristics of the operation stage at the current time, combined with CPU and memory occupancy information at the previous time, to provide sufficient context information for the LSTM model.

Prediction process: the time series relationship learned by the LSTM model during the training process, is used to predict the resource usage standard value Mₚ(t) (standard memory value and standard CPU occupancy rate) within a future time period.

Standard value output: the standard value Mₚ(t) outputted by the LSTM model is an “ideal” value of future resource usage inferred by the model based on historical data. These standard values serve as benchmarks for health assessment and are used to compare with actual memory usage data.

2 Comparison with Actual Memory Usage Conditions:

Acquiring actual memory usage data: monitoring the actual memory waveform My (t) of the system in real time, i.e., the current memory occupancy of the system.

Calculating the difference: calculating the difference between the actual memory waveform Mᵣ(t) and the predicted standard value Mₚ(t), specifically:

$$D ( t ) = \vert {M}_{r} ( t ) - {M}_{p} ( t ) \vert$$

Where D(t) is the difference value at the current time point t, representing the deviation between the actual memory usage and the predicted standard value.

### 3 Calculating the Difference Increment:

Calculating the difference increment ΔD(t): in order to detect the occurrence of memory leakage, calculating the rate of change of the difference D(t), i.e., the difference increment, is required:

$$Δ D ( t ) = diff ( D ( t ) )$$

Herein, diff(D(t)) represents the difference increment calculated based on the variation of the difference value D(t) over time, reflecting changes in the deviation between the actual memory usage and the standard value.

### 4 Detecting Memory Leakage

Determining whether the difference increment exceeds a threshold: if the difference increment ΔD(t)>leakageThreshold, it is considered that a memory leakage has occurred. This threshold is determined by experimental data or experience, signifying that the deviation between the actual memory usage and the predicted value increases excessively fast, suggesting that there may be a resource leakage.

Accordingly, the memory leakage state isLeakage(t) is set as follows:

$$isLeakage ( t ) = \{ \begin{matrix}1 , if Δ D ( t ) > leakageThreshold \\ 0 , otherwise\end{matrix}$$

Where isLeakage(t)=1 indicates that a memory leakage is detected in the system, and isLeakage(t)=0 indicates that no memory leakage is detected.

### Step 5: Health Index Calculation and Feedback Adjustment

Calculating the health index H(t): calculating the health index of the system based on the actual difference D(t), defined as:

$$H ( t ) = 1 - \frac{D ( t )}{max {M}_{p} ( t )}$$

The health index H(t) indicates the degree of health of the system; the smaller the difference D(t) is, the higher the health index is. The health index is configured to evaluate the health status of resource usage of the system in real time.

Introducing a time decay factor: in order to simulate the decay of the health status over time, introducing a time decay factor

$${e}^{- \frac{t}{τ}} ,$$

where τ is a decay constant controlling the decay speed. This decay factor ensures that the health status gradually decreases over time, preventing an overly optimistic health assessment over an excessively long period of time.

Adjusting the health index in a memory leakage state: if a memory leakage is detected, i.e., isLeakage(t)=1, then the health index will decline rapidly. At this time, the health index is multiplied by the decay factor to represent the rapid deterioration of the health status of the system:

$${H}_{result} ( t ) = \{ \begin{matrix}{H}_{withT} ( t ) ifisLeakag e ( t ) = 1 \\ H ( t ) otherwise\end{matrix}$$

Where

$${H}_{withT} ( t ) = H ( t ) {e}^{- \frac{t}{τ}}$$

is the health index after the time decay is introduced, representing the rapid decline of the health status of the system in the case of memory leakage.

### Step 6: Feedback Adjustment During the Prediction Period

Feedback adjustment: if the system detects no memory leakage, using the actual memory waveform Mᵣ(t) as an input, and continuing to predict the standard value at the next time point; if a memory leakage is detected, using the predicted standard memory waveform Mₚ(t) as an input for the next period instead of using the actual memory waveform Mᵣ(t). This feedback mechanism can prevent memory leakage from adversely affecting future predictions and ensure the accuracy of the system health assessment.

Cyclic prediction: the prediction cycle performs iterative prediction in the prediction period at 10-second and 20-second time steps to continuously monitor the health status and the resource usage of the system.

The disclosure dynamically predicts standard values of the CPU occupancy rate and memory allocation in the PCS through LSTM. The LSTM network has the ability to process time series data and can accurately capture the long-term dependence and dynamic change characteristics of resource usage, providing a benchmark reference for health assessment. This method significantly improves the accuracy and real-time performance of resource usage prediction in complex operating environments. A memory leakage detection method based on standard value prediction is proposed. By calculating the difference between the actual resource usage value and the predicted standard value and the difference increment, it can quickly determine whether there is a memory leakage in the system. This method can track the dynamic trend of memory leakage in real time and improve the accuracy of system fault detection.

The disclosure introduces a time decay factor, to dynamically adjust the health index, and simulate changes in the health status of the system over time. When a memory leakage is detected, the health index declines rapidly, which intuitively reflects the deterioration of system health, and supports the operation and maintenance personnel in responding quickly. In terms of processing of waveform characteristics of memory allocation, feature embedding and feature separation strategies are proposed. By feature embedding, the ability to model the nonlinear relationship between the system state and the resource usage is enhanced. At the same time, by adopting the feature separation method for busy and non-busy regions, the interference of resource fluctuations in different operating stages is effectively reduced, and the prediction accuracy is further improved.

The disclosure introduces a feedback mechanism which dynamically adjusts the prediction input according to memory leakage detection results, thereby ensuring the accuracy of future prediction. By using the actual value as the input for the next period when there is no memory leakage and using the standard value when a memory leakage occurs, the impact of memory leakage on model performance is avoided.

In order to confirm the technical effects of the present disclosure, experimental verification is carried out.

### I. Verification of Model Prediction Accuracy

In the experiment, the optimized model accurately predicted PCS memory allocation and CPU utilization. In the comparative experiment, the basic model, the enhanced embedded model, and the final optimized model were used to perform predictions respectively. The specific steps are as follows:

### Experimental Design

Selecting time series data of the memory allocation and CPU utilization rate generated during PCS operation.

Applying the basic model, the enhanced embedded model, and the final optimized model to the same test dataset.

Comparing deviations of predicted values from actual values for the three models.

### Experimental Results

FIG. 1 shows the prediction results of the basic model, the enhanced embedded model, and the final optimized model.

The Curve I represents the actual memory usage value.

The Curve II is the prediction result of the basic model, and the deviation is large.

The Curve III is the prediction result of the enhanced embedded model, and the accuracy is improved.

The Curve IV is the prediction result of the final optimized model, which is highly consistent with the actual value.

The results show that the final optimized model significantly reduces the deviation and meets the prediction accuracy requirements of PCS.

### Performance Evaluation:

Comparing predicted waveforms with actual waveforms, and calculating mean square errors (MSEs), mean absolute errors (MAEs), and the score quantifying model performance (R²).

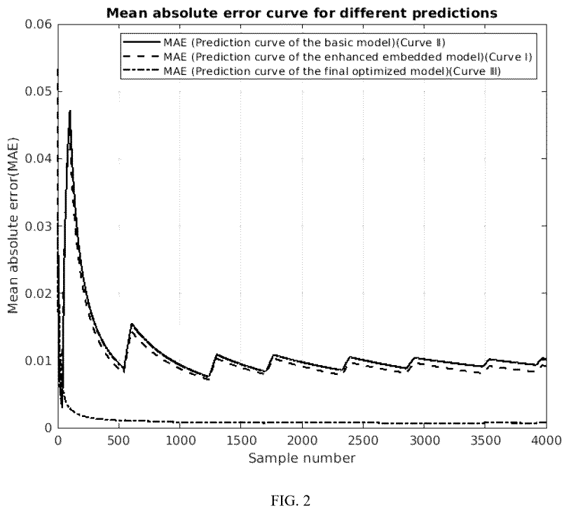

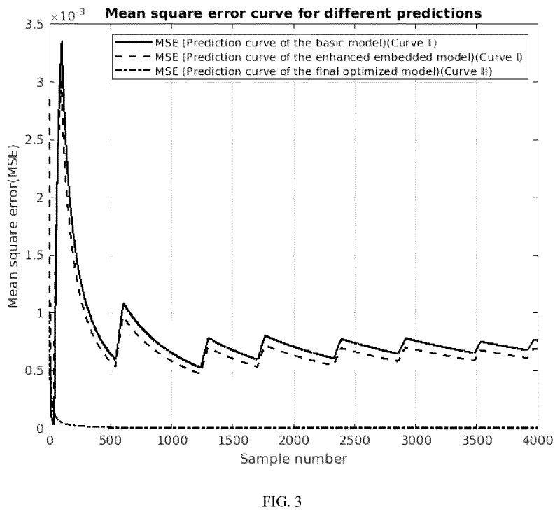

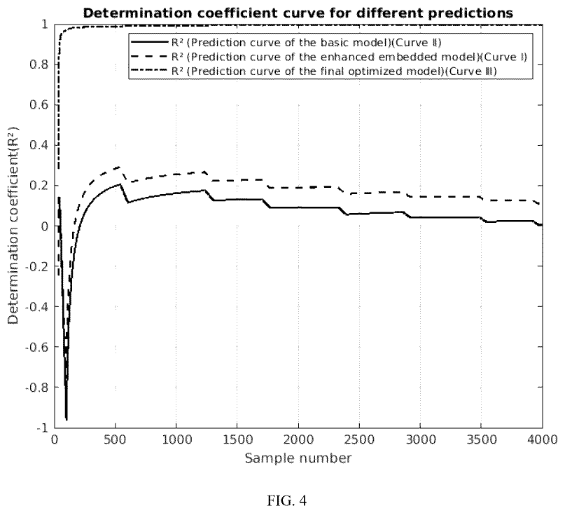

The experimental results are shown in FIGS. 1-4, and the final optimized model has the highest fitting degree with the actual waveform. The final optimized model has the lowest MSE and MAE, and the highest R² score, verifying its superior prediction ability.

### II. Verification of Short-Term Prediction Ability

In this experiment, the ability of the model to predict the resource usage condition in a short period of time is verified. The specific steps are as follows:

### Prediction Method:

Setting the length of the prediction window to 200 seconds and predicting memory allocation and CPU utilization rate within the future 10 seconds using time series data.

After each prediction, taking the predicted value as an input for the next round of prediction, and performing 10 consecutive iterations.

Moving the sliding window forward by 1 second each time and repeating the above process to generate prediction results covering multiple time periods.

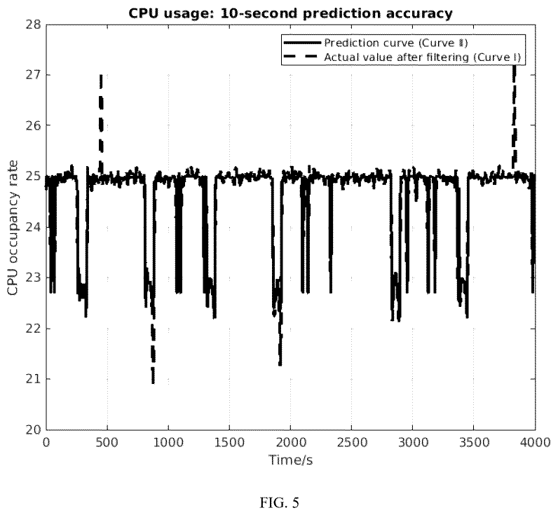

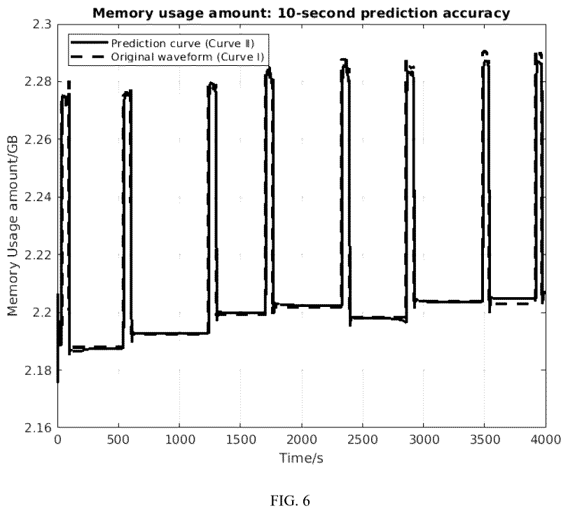

The experimental results are shown in FIG. 5 and FIG. 6, showing that the memory allocation value and CPU utilization rate within the 10-second prediction range predicted by the model are highly consistent with actual values. Experiments prove that the model can effectively capture the dynamic changes during system operation and provide precise benchmark values for health assessment.

The present disclosure possesses the following effects:

### 1. Improving Prediction Accuracy:

By introducing LSTM, the long-term dependence and dynamic change characteristics of resource usage in PCS are effectively captured. By combining feature embedding and feature separation strategies, the prediction accuracy of the CPU occupancy rate and memory allocation is significantly improved, especially under conditions of complex periodic waveforms.

### 2. Achieving Dynamic Health Assessment:

Based on the predicted standard value of resource usage, and comparing it in real-time with the actual value, the health status of the system can be accurately determined. By combining with the time decay mechanism of health index, the system becomes more intuitive in the dynamic changes of health status, thereby supporting rapid diagnosis and locating of potential problems.

### 3. Real-Time and Precise Memory Leakage Detection:

The proposed memory leakage detection algorithm can identify a memory leakage trend in real time by calculating the difference between the actual value and the standard value, and the difference increment. This method can effectively avoid misjudgments caused by resource fluctuation and improve the sensitivity and reliability of system fault detection.

### 4. Reducing the Impact of System Anomalies on Prediction:

Through the feedback adjustment mechanism, when memory leakage occurs, the predicted standard value is used instead of the actual value as the input for the next period, which prevents the negative impact of memory leakage on the model prediction, and maintains the high efficiency and accuracy of resource usage prediction.

### 5. Enhancing the Adaptability and Versatility of the Model:

By adopting a sliding window method and multi-stage training data, the adaptability of the LSTM model to different scenarios during PCS operation is enhanced. Whether in an initialization, operation or abnormal stage, the technical solution of the present disclosure can effectively respond.

### 6. Improving the Stability and Safety of System Operation:

Through the real-time feedback of the health index and memory leakage detection results, the system can identify and respond to potential risks at an early stage, reduce system interruptions or experimental delays caused by failures, and improve the reliability and safety of system operation.

### 7. Supporting Multi-Dimensional Resource Evaluation and Optimization:

The technical solution of the disclosure is not only applicable to the prediction of the CPU occupancy rate and memory allocation but can also be extended to other resources (such as network bandwidth, disk occupancy, etc.), thus providing a general solution for the overall resource optimization and health evaluation of the system.

The above-described specific embodiments are only a few optional embodiments of the present disclosure. Based on the technical solution of the present disclosure and the related teachings of the above-described embodiments, those skilled in the art can make various alternative improvements and combinations to the above-described specific embodiments.

1. A resource usage prediction method of a plasma control system based on LSTM, the method comprising the steps of:
data preprocessing and feature extraction: collecting and processing operation data of the plasma control system, selecting and standardizing feature metrics reflecting an operation state of the system, which specifically comprises:
data collection: collecting time series data about resource usage including CPU occupancy rate and memory allocation during operation of the system, ensuring that the data includes resource consumption conditions under different operation states of the system;
feature selection: selecting feature metrics reflecting the running state of the system, wherein the feature metrics include:
algorithm type: a type of control algorithm currently running;
trigger state: a state of the system when the system is in different trigger conditions;
operation stage: an operation stage of the control system;
dynamic resource utilization: dynamically changing resource utilization data, including historical CPU occupancy rate and memory allocation;
standardization processing: standardizing input features to eliminate a scale difference between different features;
introduction of an LSTM network for time series prediction: constructing an LSTM model, training the model using historical data to predict a resource usage standard value at a future time point, and enhancing an adaptability of the model through a sliding window method;
feature embedding and feature separation strategies: generating embedded vectors for a system state, and separating a memory waveform according to busy and non-busy regions, which specifically comprises the following steps:
feature embedding: performing a statistical analysis on the system state to generate the embedded vectors instead of traditional digital coding, wherein the system state includes the algorithm type and the trigger state;
feature separation: in view of an obvious square wave characteristic of the memory waveform, separating the memory occupancy rate into busy regions and non-busy regions, and using the separated busy and non-busy regions as independent input features respectively for the LSTM model to learn, the obvious square wave characteristic of the memory waveform is that the busy regions and the non-busy regions change alternately;
standard value prediction and memory leakage detection: collecting operation data of the system in real time, applying the LSTM model to predict a resource usage standard value in the future, calculating and monitoring a difference between the actual memory waveform and the predicted standard value and an increment of the difference to detect a memory leakage;
health index calculation and feedback adjustment: calculating a health index of the system based on the actual difference, introducing a time decay factor, and adjusting the health index when a memory leakage is detected;
feedback adjustment in the prediction period: according to a memory leakage detection result, performing feedback and adjustment on the input of the prediction, and performing cyclic predictions at a certain time step.

2. The resource usage prediction method of a plasma control system based on LSTM according to claim 1, wherein the introduction of an LSTM network for time series prediction specifically comprises:
model structure determination: constructing the LSTM model, setting an input window to 200 time steps, wherein the input features of the model include the CPU occupancy rate and the memory allocation of a previous step, and the current system state;
time series learning: training the LSTM model using historical data, wherein by learning a relationship between different system operation stages and resource usages, the model is configured to predict a resource usage standard value at a future time point;
model training: segmenting the training data into a plurality of small windows through a sliding window method, to cover all possible operation states.

3. The resource usage prediction method of a plasma control system based on LSTM according to claim 1, wherein the step of the standard value prediction comprises the following:
real-time data collection: during the operation of the system, collecting data of resource usage including CPU occupancy rate and memory allocation in real time to form a time series;
application of LSTM prediction model: predicting a resource usage condition of the system within a future time period by using the trained LSTM network model, wherein the LSTM model predicts a standard CPU occupancy rate and a memory allocation value at a future time point based on historical data, the historical data includes a CPU occupancy rate, a memory usage condition, and a control algorithm type;
input features: the input features include features of a control algorithm type, a trigger state, and a system state in the operation stage at a current time, and they are combined with CPU and memory occupation information at a previous time, to provide sufficient context information for the LSTM model;
prediction process: a time series relationship learned by the LSTM model during the training process, is used to predict the resource usage standard value Mₚ(t) in a future time period, the resource usage standard value includes a standard memory value and a standard CPU occupancy rate;
standard value output: the standard value Mₚ(t) outputted by the LSTM model is an “ideal” value of future resource usage inferred by the model based on historical data, wherein the standard value serving as a benchmark for health assessment is used to compare with actual memory usage data.

4. The resource usage prediction method of a plasma control system based on LSTM according to claim 3, wherein the memory leakage detection specifically comprises the following steps:
comparing with actual memory usage condition:
acquisition of actual memory usage data: monitoring the actual memory waveform Mᵣ(t) of the system in real time, that is, a current memory usage condition of the system;
difference calculation: calculating a difference between the actual memory waveform Mᵣ(t) and the predicted standard value Mₚ(t), that is,
$$D ( t ) = \vert {M}_{r} ( t ) - {M}_{p} ( t ) \vert$$
wherein D(t) is a difference value at a current time point t, which indicates a deviation between the actual memory usage and the predicted standard value;
difference increment calculation:
calculating the difference increment ΔD(t): in order to detect an occurrence of memory leakage, a change rate of the difference D(t), that is, the difference increment ΔD(t)=diff(D(t)), needs to be calculated, wherein diff(D(t)) is a difference increment calculating a variation of the difference value D(t) over time, which reflects the change condition of the deviation between the actual memory usage and the standard value;
memory leakage detection:
determining whether the difference increment exceeds a threshold: if the difference increment ΔD(t)>leakageThreshold, it is considered that a memory leakage has occurred, and the threshold is determined by experimental data or experience, indicating that the deviation between the actual memory usage and the predicted value increases too fast, indicating that there may be a resource leakage;
memory leakage state setting: at this time, the memory leakage state is set to
$$isLeakage ( t ) = \{ \begin{matrix}1 , if Δ D ( t ) > leakageThreshold \\ 0 , otherwise\end{matrix}$$
wherein, isLeakage(t)=1 indicates that the system has detected a memory leakage, and isLeakage(t)=0 indicates that no memory leakage was detected.

5. The resource usage prediction method of a plasma control system based on LSTM according to claim 1, wherein the health index calculation and feedback adjustment specifically comprises the following steps:
calculating the health index: in the resource usage prediction method of a plasma control system based on LSTM, the health index of the system needs to be calculated based on the actual difference, and the health index is defined as:
$$H ( t ) = 1 - \frac{D ( t )}{max {M}_{p} ( t )}$$
the health index H(t) indicates a degree of health of the system, wherein the smaller the difference D(t), the higher the health index, and the health index H(t) is configured to evaluate a health status of resource usage of the system in real time;
introducing a time decay factor: introducing the time decay factor
$${e}^{- \frac{t}{τ}} ,$$
to simulate a decay of the health status over time, wherein t is a decay constant controlling a decay speed;
health index adjustment in memory leakage state: if a memory leakage is detected, that is, isLeakage(t)=1, then the health index will decline rapidly, and the health index is multiplied by the decay factor to express a rapid deterioration of the system's health status, the calculation formula is:
$${H}_{result} ( t ) = \{ \begin{matrix}{H}_{withT} ( t ) ifisLeakag e ( t ) = 1 \\ H ( t ) otherwise\end{matrix}$$
wherein
$${H}_{withT} ( t ) = H ( t ) {e}^{- \frac{t}{τ}}$$
is the health index after the time decay is introduced, representing the rapid decline of the health status of the system in the case of memory leakage.

6. The resource usage prediction method of a plasma control system based on LSTM according to claim 1, wherein the feedback adjustment in the prediction period specifically comprises the following steps:
feedback adjustment: if the system detects no memory leakage, using the actual memory waveform Mᵣ(t) as an input, and continuing to predict the standard value at a next time point; and if a memory leakage is detected, using the predicted standard memory waveform Mₚ(t) as an input for a next period instead of using the actual memory waveform Mᵣ(t);
cyclic prediction: performing prediction iteratively in the prediction period at 10-second and 20-second time steps, to continuously monitor the health status and the resource usage of the system.
